(19) United States
(12) Patent Application Publication
(10) Pub. No.: US 2009/0237384 A1
(43) Pub. Date: Sep. 24, 2009

(54) Display device and method of automatically powering on and powering off the same

(76) Inventor: Chia-Wei Hu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/213,494

(22) Filed: Jun. 20, 2008

(30) Foreign Application Priority Data
Mar. 21, 2008 (CN) 200810026966.7

(51) Int. Cl. G09G 5/00

(52) U.S. Cl. 345/211

(57) ABSTRACT

In a method of automatically powering on and powering off a display device, the display device is switchable between a power on mode, where the display device is operable to show an image frame, and a power off mode, where the display device is unable to show an image frame. The method includes the steps of: (A) while the display device is in the power on mode, enabling the display device to detect whether there is an image signal input; and (B) in response to non-detection of the image signal input in step (A), enabling the display device to switch operation to the power off mode. The method dispenses with the need to provide a power switch button on the display device, and power consumption of the display device can be further lowered due to operation in the power off mode.

### CROSS-REFERENCE TO RELATED APPLICATION

This application claims priority of Chinese application No. 200810026966.7, filed on Mar. 21, 2008.

### BACKGROUND OF THE INVENTION

1. Field of the Invention

This invention relates to a display device, more particularly to a display device capable of powering on and powering off automatically.

2. Description of the Related Art

A display device provides a communication interface between an operator and a host. During normal operation, the display device receives a signal originated from the host, and displays content of the signal to the operator. The operator relies on the content displayed to work with the host. When the host no longer outputs the signal to the display device, the display device should enter a sleep mode or be powered off in order to save power. Ideally, the display device should enter the sleep mode or be powered off when the operator is away, when the host has a task requiring lengthy processing time, and when intervention of the operator is not required.

Referring to FIG. 1, a conventional display device 100 includes a display panel 1, a function menu button 2, function menu selection buttons 3, and a power switch button 4. When the signal is not being received, the display device 100 typically displays an “entering sleep mode” message, and subsequently enters the sleep mode automatically. While power supply to the display panel 1 is cut off during operation in the sleep mode, other electronic components in the display device 100 remain in a working state and continue to consume power. Continued power consumption of the aforesaid components is not only wasteful, but could have an adverse effect on long-term performance of the display device 100. Consequently, when it is decided that the display device 100 will not be used for a long period of time, the operator must press the power switch button 4 to power off completely the display device 100.

In practice, the display device often operates in the sleep mode for extended periods of time, such as when the operator, after powering off the host, forgets to power off the display device, or when the operator simply leaves the display device for a long period of time. As previously mentioned, the continued power consumption of the aforesaid components within the display device during operation in the sleep mode is wasteful, and ultimately shortens the service life of the display device. The applicant is currently unaware of a display device available on the market and capable of powering on and powering off automatically.

### SUMMARY OF THE INVENTION

Therefore, an object of the present invention is to provide a display device capable of powering on and off automatically without requiring operator involvement so as to reduce power consumption.

According to one aspect of the present invention, there is provided a method of automatically powering on and powering off a display device. The display device is switchable between a power on mode, where the display device is operable to show an image frame, and a power off mode, where the display device is unable to show an image frame. The method includes the steps of:

(A) while the display device is in the power on mode, enabling the display device to detect whether there is an image signal input; and

(B) in response to non-detection of the image signal input in step (A), enabling the display device to switch operation to the power off mode.

In an embodiment of the invention, the method further comprises the step of:

(C) while the display device is in the power off mode, enabling the display device to detect whether there is an image signal input and to switch operation to the power on mode in response to detection of the image signal input.

In an embodiment of the invention, step (B) includes the sub-steps of:

enabling the display device to switch operation first to a sleep mode in response to non-detection of the image signal input in step (A);

enabling the display device to detect whether there is an image signal input while the display device operates in the sleep mode; and

when the image signal input is not detected during operation of the display device in the sleep mode for a predetermined time period, enabling the display device to switch operation to the power off mode.

In an embodiment of the invention, step (B) includes the sub-steps of:

enabling the display device to switch operation first to a sleep mode in response to non-detection of the image signal input in step (A);

enabling the display device to detect whether there is a trigger signal received thereby while the display device operates in the sleep mode; and

when the trigger signal is not received during operation of the display device in the sleep mode for a predetermined time period, enabling the display device to switch operation to the power off mode.

In an embodiment of the invention, the display device is connected to an external device, and the image signal input and the trigger signal originate from the external device.

In an embodiment of the invention, an on screen display (OSD) function menu of the display device includes a power off option, and the method further comprises the step of:

(D) while the display device operates in the power on mode, enabling the display device to detect presence of a power off command generated as a result of selection of the power off option and to switch operation to the power off mode in response to detection of the power off command.

In an embodiment of the invention, the method further comprises, after step (D), the step of:

(E) while the display device operates in the power off mode, enabling the display device to detect whether there is a trigger signal received thereby and to switch operation to the power on mode in response to receipt of the trigger signal.

In an embodiment of the invention, the display device includes a plurality of buttons for use with the OSD function menu, and the trigger signal in step (E) is generated as a result of pressing one of the buttons.

In an embodiment of the invention, the display device is connected to an external device, and the image signal input and the trigger signal in step (E) originate from the external device.

According to another aspect of the present invention, there is provided a display device capable of automatically powering on and powering off. The display device is switchable between a power on mode, where the display device is operable to show an image frame, and a power off mode, where the display device is unable to show an image frame. The display device comprises:

a display unit for showing the image frame;

a power supply unit coupled electrically to the display unit, the power supply unit supplying power to the display unit when the display device operates in the power on mode, and cutting off power supply to the display unit when the display device operates in the power off mode; and

a processing unit coupled electrically to the display unit and the power supply unit, and operable to convert an external image signal input into image frame content for output to the display unit, and to switch operation of the display device from the power on mode to the power off mode when the image signal input is not detected thereby.

In an embodiment of the invention, when the processing unit detects the image signal input while the display device operates in the power off mode, the processing unit switches operation of the display device to the power on mode.

In an embodiment of the invention, when the processing unit does not detect the image signal input while the display device operates in the power on mode, the processing unit enables the display device to switch operation first to a sleep mode, detects whether there is an image signal input or whether there is a trigger signal received thereby while the display device operates in the sleep mode, and enables the display device to switch operation to the power off mode when the image signal input is not detected or when the trigger signal is not received during operation of the display device in the sleep mode for a predetermined time period.

In an embodiment of the invention, the processing unit is adapted to be connected electrically to an external device, and the image signal input and the trigger signal originate from the external device.

In an embodiment of the invention, the display unit includes an on screen display (OSD) function menu that has a power off option, and while the display device operates in the power on mode, the processing unit detects presence of a power off command generated as a result of selection of the power off option and switches operation of the display device to the power off mode in response to detection of the power off command.

In an embodiment of the invention, while the display device operates in the power off mode, the processing unit detects whether there is a trigger signal received thereby and switches operation of the display device to the power on mode in response to receipt of the trigger signal.

In an embodiment of the invention, the display unit includes an on screen display (OSD) function menu and a plurality of buttons for use with the OSD function menu, and the trigger signal is generated as a result of pressing one of the buttons.

In an embodiment of the invention, the processing unit is adapted to be connected electrically to an external device, and the image signal input and the trigger signal originate from the external device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram of a conventional flat panel display device;

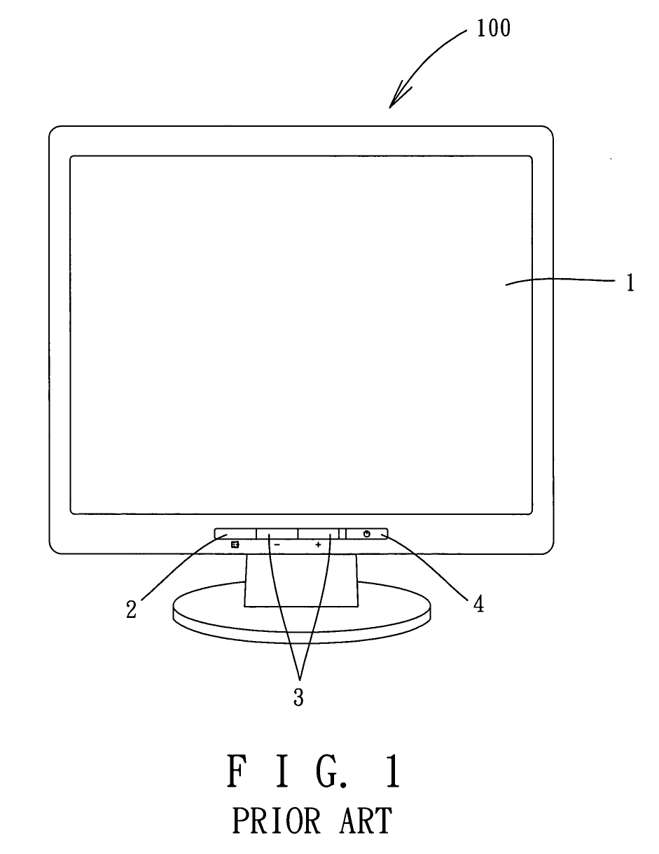

FIG. 2 is a schematic diagram of a preferred embodiment of a display device capable of automatically powering on and powering off according to the present invention;

FIG. 3 is a schematic circuit block diagram of the preferred embodiment;

FIG. 4 is a flow chart of a preferred embodiment of a method for automatically powering on and powering off the display device according to the present invention; and

FIG. 5 is a schematic diagram showing an OSD function menu of the display device of the preferred embodiment.

### DETAILED DESCRIPTION OF THE PREFERRED EMBODIMENT

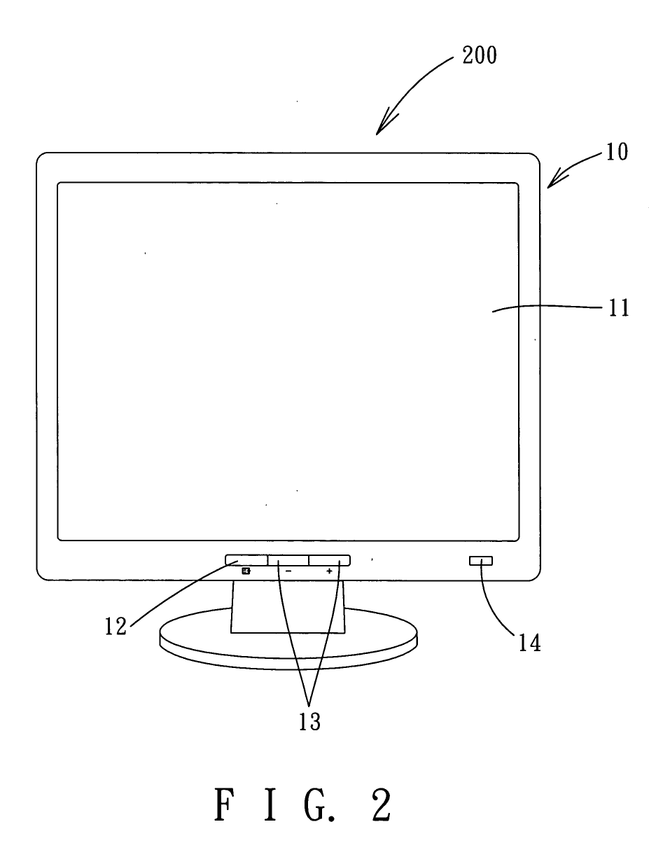

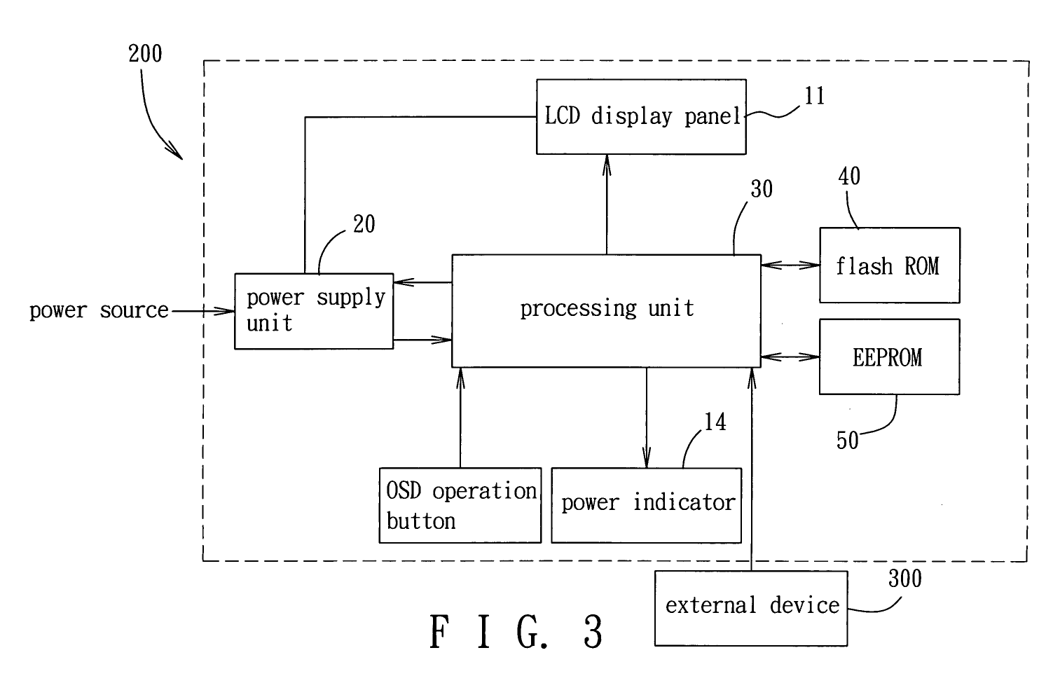

FIGS. 2 and 3 illustrate an outer appearance and a schematic circuit block diagram of a preferred embodiment of a display device 200 capable of automatically powering on and powering off according to this invention. In this embodiment, the display device 200 is a flat panel display device, such as a liquid crystal display device or a plasma display device. Like the conventional liquid crystal display device or other type of conventional display device, the display device 200 of the preferred embodiment is switchable between a power on mode, where the display device 200 is operable to show an image frame, and a power off mode, where the display device 200 is unable to show an image frame. However, while the conventional display device requires the operator to press a power switch button on the display device to switch between the power on and the power off modes, the display device 200 of the preferred embodiment does not need a power switch button, and is capable of switching automatically between the power on and the power off modes based on the presence or absence of an image input signal.

As shown in FIGS. 2 and 3, the display device 200 of the preferred embodiment includes a display unit 10, a power supply unit 20, and a processing unit 30.

The display unit 10 includes a liquid crystal display panel 11 for showing the image frame, and a plurality of buttons for use with an on screen display (OSD) function menu (including an OSD function button 12 and OSD function menu selection buttons 13) and a power indicator (a light-emitting diode or LED) 14 arranged below a bottom edge of the liquid crystal display panel 11. The power indicator 14 is not essential.

The power supply unit 20 is coupled electrically to the display panel 11, the power indicator 14, and the processing unit 30. When the display device 200 operates in the power on mode, the power supply unit 20 supplies power to the liquid crystal display panel 11 and the power indicator 14. When the display device 200 operates in the power off mode, the power supply unit 20 cuts off power supply to the liquid crystal display panel 11 and the power indicator 14. In all operational modes of the display device 200, the power supply unit 20 continues to supply power to the processing unit 30.

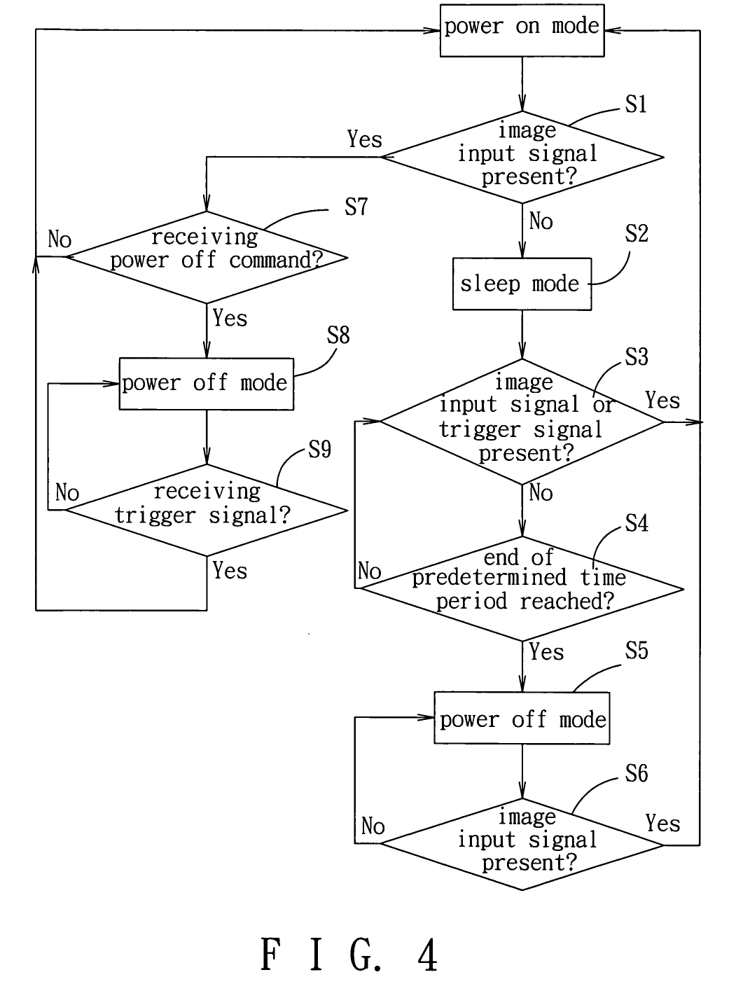

In this embodiment, the processing unit 30 is a scaler coupled electrically to the display unit 10 and the power supply unit 20, and operable to convert an external image signal input from an external device 300 (i.e., any device capable of supplying a host image signal, such as a computer or TV signal receiver) into image frame content for output to the display panel 11 of the display unit 10, and to switch operation of the display device 200 from the power on mode to the power off mode when the image signal input is not detected thereby. The processing unit 30 of this embodiment can, through use of peripheral memory such as a flash read-only memory (ROM) 40 that is loaded with a program (firmware), perform the function of automatically powering on and powering off the display device 200 in accordance with the following steps shown in FIG. 4:

In step S1, while the display device 200 operates in the power on mode, the processing unit 30 detects whether the image signal input is being received from the external device 300. If the image signal input is not detected, such as in the case that the external device 300 is powered off or is operating in a sleep mode, the flow proceeds to step S2.

In step S2, the processing unit 30 switches operation of the display device 200 from the power on mode to a sleep mode by issuing a sleep mode command to the power supply unit 20. The power supply unit 20 then cuts off power supply to the liquid crystal display panel 11 of the display device 200 in response to the sleep mode command. The flow then proceeds to step S3.

In step S3, while the display device 200 operates in the sleep mode, the processing unit 30 continues to detect whether the image signal input is being received from the external device 300. In addition, the processing unit 30 detects whether a trigger signal (such as one issued from the external device 300 as a result of operating a keyboard or a mouse) is being received from the external device 300. If the image signal input or the trigger signal is detected, the processing unit 30 switches operation of the display device 200 from the sleep mode to the power on mode. Otherwise, the flow proceeds to step S4.

In step S4, the processing unit 30 determines whether a predetermined time period (such as 3 minutes) has ended. If it is determined that the predetermined time period has ended, the flow proceeds to step S5. Otherwise, the flow returns to step S3.

In step S5, the processing unit 30 switches operation of the display device 200 from the sleep mode to the power off mode by issuing a power off mode command to the power supply unit 20. The power supply unit 20 then cuts off power supply to the display panel 11, the power indicator 14, and other components not needed in the power off mode, such as the Electrically Erasable Programmable Read-Only Memory (EEPROM) 50 (see FIG. 3) that stores display setting information, in response to the power off mode command. The flow then proceeds to step S6.

When the display device 200 operates in the power off mode, the processing unit 30 is still supplied with power from the power supply unit 20, and therefore continues to detect whether the image signal input is being received from the external device 300, as shown in step S6. If the image signal input is detected, the processing unit 30 switches operation of the display device 200 from the power off mode to the power on mode, by issuing a power on mode command to the power supply unit 20. The power supply unit 20 then supplies power to the display panel 11, the power indicator 14, and other components needed in the power on mode in response to the power on mode command. Otherwise, the display device 200 continues operation in the power off mode entered in step S5.

In other embodiments, the above-described steps pertaining to the sleep mode (S2-S4) could be omitted so that when the image signal input is not detected during operation of the display device 200 in the power on mode, the processing unit 30 switches operation of the display device 200 from the power on mode directly to the power off mode.

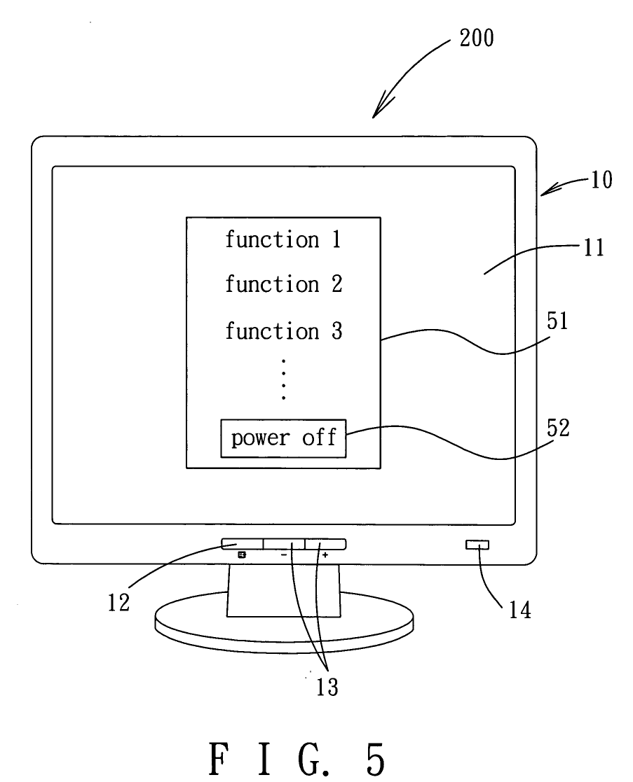

For convenience, the display device 200 of the preferred embodiment can be powered off manually while operating in the power on mode and receiving the image signal input. To this end, an OSD function menu 51 of the display unit 10 includes a power off option 52 as shown in FIG. 5. The power off option 52 is selected according to convention by pressing the OSD function menu button 12 and the function menu selection buttons 13 to select the power off option 52 of the OSD function menu 51 on the liquid crystal display panel 11.

Accordingly, while the display device 200 is receiving the image signal input during operation in the power on mode, the processing unit 30 detects whether a power off command has been generated as a result of selection of the power off option 52 as shown in step S7. If the power off command is detected, the flow proceeds to step S8, wherein the processing unit 30 switches operation of the display device 200 from the power on mode to the power off mode in response to detection of the power off command.

If it is desired to power on the display device 200, the operator only has to press any button on the display unit 10, such as the function menu button 12 or the function menu selection buttons 13, or press any key on a computer keyboard or a mouse to issue a trigger signal to the processing unit 30.

Accordingly, while the display device 200 operates in the power off mode, the processing unit 30 detects whether the trigger signal is being received as shown in step S9. If receipt of the trigger signal is detected, the processing unit 30 switches operation of the display device 200 from the power off mode to the power on mode. Otherwise, the display device 200 continues operating in the power off mode entered in step S8.

In sum, the present invention provides a display device 200 capable of automatically powering on and powering off based on the presence of the image signal input, and a method of automatically powering on and powering off the same, which, a side from further reducing power consumption of the display device 200 due to operation in the power off mode, reduce the time the display device 200 is powered on, and promote long service life of the display device 200. Moreover, since the display device 200 does not need a power switch button, the outer appearance of the display device 200 can be enhanced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of automatically powering on and powering off a display device, the display device being switchable between a power on mode, where the display device is operable to show an image frame, and a power off mode, where the display device is unable to show an image frame, said method including the steps of:
(A) while the display device is in the power on mode, enabling the display device to detect whether there is an image signal input; and
(B) in response to non-detection of the image signal input in step (A), enabling the display device to switch operation to the power off mode.

2. The method of automatically powering on and powering off a display device as claimed in claim 1, further comprising the step of:
(C) while the display device is in the power off mode, enabling the display device to detect whether there is an image signal input and to switch operation to the power on mode in response to detection of the image signal input.

3. The method of automatically powering on and powering off a display device as claimed in claim 1, wherein step (B) includes the sub-steps of:
enabling the display device to switch operation first to a sleep mode in response to non-detection of the image signal input in step (A);
enabling the display device to detect whether there is an image signal input while the display device operates in the sleep mode; and
when the image signal input is not detected during operation of the display device in the sleep mode for a predetermined time period, enabling the display device to switch operation to the power off mode.

4. The method of automatically powering on and powering off a display device as claimed in claim 1, wherein step (B) includes the sub-steps of:
enabling the display device to switch operation first to a sleep mode in response to non-detection of the image signal input in step (A);
enabling the display device to detect whether there is a trigger signal received thereby while the display device operates in the sleep mode; and
when the trigger signal is not received during operation of the display device in the sleep mode for a predetermined time period, enabling the display device to switch operation to the power off mode.

5. The method of automatically powering on and powering off a display device as claimed in claim 4, wherein the display device is connected to an external device, and the image signal input and the trigger signal originate from the external device.

6. The method of automatically powering on and powering off a display device as claimed in claim 1, wherein an on screen display (OSD) function menu of the display device includes a power off option, said method further comprising the step of:
(D) while the display device operates in the power on mode, enabling the display device to detect presence of a power off command generated as a result of selection of the power off option and to switch operation to the power off mode in response to detection of the power off command.

7. The method of automatically powering on and powering off a display device as claimed in claim 6, further comprising the step of:
(E) while the display device operates in the power off mode, enabling the display device to detect whether there is a trigger signal received thereby and to switch operation to the power on mode in response to receipt of the trigger signal.

8. The method of automatically powering on and powering off a display device as claimed in claim 7, wherein the display device includes a plurality of buttons for use with the OSD function menu, and the trigger signal is generated as a result of pressing one of the buttons.

9. The method of automatically powering on and powering off a display device as claimed in claim 7, wherein the display device is connected to an external device, and the image signal input and the trigger signal originate from the external device.

10. The method of automatically powering on and powering off a display device as claimed in claim 3, wherein power supply to a display panel of the display device is cut-off when the display device operates in the sleep mode, and power supply to the display panel and at least one other electronic component of the display device is cut-off when the display device operates in the power-off mode.

11. A display device capable of automatically powering on and powering off, said display device being switchable between a power on mode, where said display device is operable to show an image frame, and a power off mode, where said display device is unable to show an image frame, said display device comprising:
a display unit for showing the image frame;
a power supply unit coupled electrically to said display unit, said power supply unit supplying power to said display unit when said display device operates in the power on mode, and cutting off power supply to said display unit when said display device operates in the power off mode; and
a processing unit coupled electrically to said display unit and said power supply unit, and operable to convert an external image signal input into image frame content for output to said display unit, and to switch operation of said display device from the power on mode to the power off mode when the image signal input is not detected thereby.

12. The display device capable of automatically powering on and powering off as claimed in claim 11, wherein, when said processing unit detects the image signal input while said display device operates in the power off mode, said processing unit switches operation of said display device to the power on mode.

13. The display device capable of automatically powering on and powering off as claimed in claim 11, wherein, when said processing unit does not detect the image signal input while said display device operates in the power on mode, said processing unit enables said display device to switch operation first to a sleep mode, detects whether there is an image signal input while said display device operates in the sleep mode, and enables said display device to switch operation to the power off mode when the image signal input is not detected during operation of said display device in the sleep mode for a predetermined time period.

14. The display device capable of automatically powering on and powering off as claimed in claim 11, wherein, when said processing unit does not detect the image signal input while said display device operates in the power on mode, said processing unit enables said display device to switch operation first to a sleep mode, detects whether there is a trigger signal received thereby while said display device operates in the sleep mode, and enables said display device to switch operation to the power off mode when the trigger signal is not received during operation of said display device in the sleep mode for a predetermined time period.

15. The display device capable of automatically powering on and powering off as claimed in claim 14, wherein said processing unit is adapted to be connected electrically to an external device, and the image signal input and the trigger signal originate from the external device.

16. The display device capable of automatically powering on and powering off as claimed in claim 11, wherein said display unit includes an on screen display (OSD) function menu that has a power off option,
wherein, while said display device operates in the power on mode, said processing unit detects presence of a power off command generated as a result of selection of the power off option and switches operation of said display device to the power off mode in response to detection of the power off command.

17. The display device capable of automatically powering on and powering off as claimed in claim 11, wherein, while said display device operates in the power off mode, said processing unit detects whether there is a trigger signal received thereby and switches operation of said display device to the power on mode in response to receipt of the trigger signal.

18. The display device capable of automatically powering on and powering off as claimed in claim 17, wherein said display unit includes an on screen display (OSD) function menu and a plurality of buttons for use with said OSD function menu, and the trigger signal is generated as a result of pressing one of said buttons.

19. The display device capable of automatically powering on and powering off as claimed in claim 17, wherein said processing unit is adapted to be connected electrically to an external device, and the image signal input and the trigger signal originate from the external device.

20. The display device capable of automatically powering on and powering off as claimed in claim 13, wherein said display unit includes a display panel and at least one other electronic component, power supply to said display panel of said display unit being cut-off when said display device operates in the sleep mode, power supply to said display panel and said at least one other electronic component being cut-off when said display device operates in the power-off mode.
